(19) United States
(12) Patent Application Publication
(10) Pub. No.: US 2003/0048471 A1
(43) Pub. Date: Mar. 13, 2003

(54) System and method for providing in-flight computer printing services on an aircraft

(76) Inventor: Mark A. Lundgren, Corona, CA (US)

Correspondence Address: HARNESS, DICKEY & PIERCE, P.L.C., P.O. BOX 828, BLOOMFIELD HILLS, MI, 48303, US

(21) Appl. No.: 09/949,695

(22) Filed: Sep. 10, 2001

(51) Int. Cl. B41J 1/00; G06F 15/00

(52) U.S. Cl. 358/1.15

(57) ABSTRACT

A system and method for printing documents by a passenger or crew member, from the individual's personal computing device carried on-board the aircraft, while travelling on the aircraft. The system involves connecting the computing device such as a laptop computer of the user to an aircraft based network. The network is connected to an on-board server. In a first preferred embodiment, the on-board server connects via a communications link established via a satellite to a ground based server with a resident printing services application running thereon. In a second preferred embodiment, the aircraft based server has resident the printing services application for receiving and processing user printing requests. The user selects printing and delivery options through the printing services application including the option of printing to user designated remote locations. The document is then printed pursuant to the specifications provided by the user.

### FIELD OF THE INVENTION

The present invention relates generally to network based computer printing services, and specifically to network based computer printing services on an in-flight aircraft.

### BACKGROUND OF THE INVENTION

Airline passengers frequently bring on-board an aircraft their computing devices including laptop computers, hand-held computers and cellular telephones or pagers with Internet access capability. These various devices can be used by passengers to perform a wide variety of computing operations including reviewing web pages, gathering information, creating documents and performing other work or leisure related activities. These devices are convenient for use during a commercial air flight where several hours can pass between destinations. Due to the proliferation of computing devices, systems have developed to integrate their use in areas where they have not been fully utilized, such as on commercial aircraft.

For commercial aircraft, greater utilization has developed by first integrating a network in the aircraft to allow for connecting the computerized devices to the network in order to access additional services. For example, local area networking has been integrated into present day aircraft in order to allow passengers to connect to the local area network in order to access the Internet and perform other networking related functions. Networking has been developed for specific application on commercial aircraft. For example, Connexion By Boeing™ is a consumer and commercial airline service that offers high-speed data communication services through a space-based network. The system offers air travelers high-speed intranet, email, and Internet services while in-flight. To use these services, a passenger must connect their computing device to a local area network on the aircraft that in turn interfaces the computerized device to ground based Internet or other data/information services.

While in the process of performing computer operations, including word processing, spreadsheet generation and reviewing documents, either created or located in files or on the Internet, passengers would benefit from the ability to print documents. Currently, however, document printing capabilities while in-flight are limited. One solution is for the user to bring on-board an individual printing device to connect to his/her computing device. This solution requires each passenger that plans on printing to bring a bulky printing device into an area of limited space. This is not only inconvenient for passengers, but could pose a hazard to passengers and crew by seriously obstructing the area in front of each user's seat. Another solution is to provide an on-board printer for passengers to connect to through an on-board local area network. This solution, while adequate for some printing operations, would be limited in the variety of printing options available due to the space and weight constraints common for commercial aircraft. Furthermore, this option does not allow for remote printing.

Therefore, there is a need for a system to provide on-board printing services to passengers in an aircraft that is not limited to only printing documents from a printer on-board the aircraft, but which includes the ability to also print at remote locations. Further, there is a commercial need to be able to track printing operations and perform accounting services, including an ability to charge for the printing services offered.

It is, therefore, an object of the invention to provide a system for printing documents by connecting a computing device to a network on an aircraft where the network is connected to a printer. It is a further object of invention to offer passengers options on how the documents will be printed, including the location (i.e., remote from the aircraft) where the document will be printed, and performing accounting functions for the printing services used.

### SUMMARY OF THE INVENTION

In accordance with the teachings of the present invention, a system for printing documents through an aircraft-based network is provided for use by aircraft passengers and crew members. The system involves connecting a computing device of a user, such as a laptop computer or handheld computer, to an aircraft-based network. In a first preferred embodiment, the aircraft based network connects the computing device to an Internet web site for accessing a printing management application. In a second preferred embodiment, the aircraft based network is connected to an on-board server for receiving and processing any requests by users of the system. The on-board server contains the printing management application for receiving and processing printing requests by users connected to the system. In the preferred embodiments the requests for printing are sent to the printing management application which directs the printing to take place on an on-board printer or at an alternative remote destination. This includes printing at a designated airport or at other locations designated by the user. The printing management application also provides for tracking the printing of a document and for charging the passenger for the printing services requested.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating an aircraft to ground based network for printing services in accordance with a preferred embodiment of the present invention;

FIG. 2 is a simplified block diagram showing a plurality of passengers within the aircraft of FIG. 1 with their computing devices connected to the network on the aircraft for accessing printing services; and

FIG. 3 is a flow chart illustrating the steps performed in providing printing services in accordance with a method of the present invention.

### DETAILED DESCRIPTION OF THE PREFERRED EMBODIMENTS

The following description of the preferred embodiments is merely exemplary in nature and is in no way intended to limit the invention, its application, or uses.

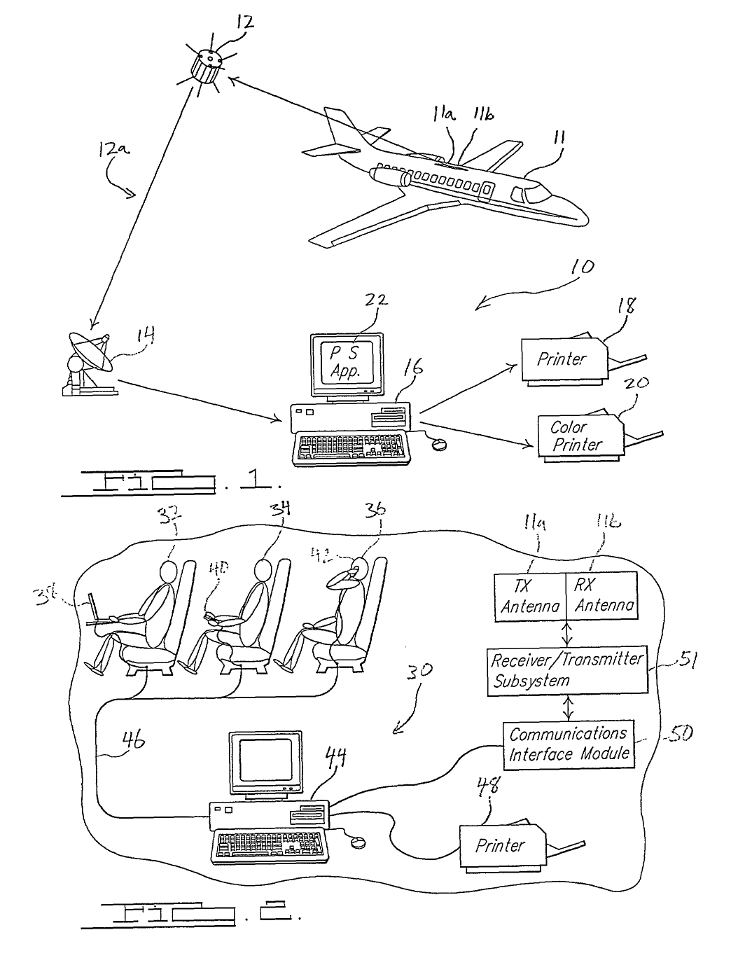

In FIG. 1, an aircraft 11 is connected to a ground based server 16 via a space-based communications link 12a for providing aircraft in-flight computing services in accordance with a preferred embodiment 10 of the system of the present invention. The aircraft 11 sends a networking signal from an onboard antenna 11a to a satellite 12 that is relayed (i.e., transponded) to a ground-based satellite dish antenna 14 that in turn transmits the networking signal to the ground based server 16. In a first preferred embodiment there is resident in the ground based server a printing services application 22 for receiving and processing print requests. Although ground based server 16 is illustrated as a single server, a plurality of servers could comprise the ground based server 16. Further, the plurality of servers could be at a plurality of locations. The ground based server 16 is connected to a plurality of printers including a first printer 18 and a second, color printer 20. Ground based printers 18, 20 illustrate that a plurality of various printers can be located at a plurality of locations.

Now referring to FIG. 2, a local area network 30 disposed in the aircraft 10 provides a plurality of passengers 32, 34, 36 with their respective portable computing devices 38, 40, 42 access to an aircraft based server 44 via a wired network 46. In Illustrating a plurality of computing devices available for connection to the local area network 30, the first passenger 32 operates a laptop computer 38, the second passenger 34 operates a Personal Digital Assistant (PDA), and the third passenger 36 operates a phone 42 with Internet accessibility. The local area network 30 includes a printer 48 attached to the aircraft based server 44. Attached to the aircraft based server 44 is a communications interface module 50 in communication with a receiver/transmitter subsystem 51 carried on the aircraft 11. The subsystem 51 is, in turn, in communication with the antenna 11a, which forms a transmit antenna. Antenna 11b forms a receive antenna to provide two-way communication with the ground-based antenna 14 (FIG. 1). The antennas 11a and 11b send and receive the networking signal from the aircraft based local area network 30 to the communications link 12a to ground base server 44. Although the local area network 30 is illustrated as a hard-wired network 46, a wireless network could just as easily be used with the present invention. In a second preferred embodiment the printing services application 22 is resident on the aircraft based server 44 rather than the ground based server 16.

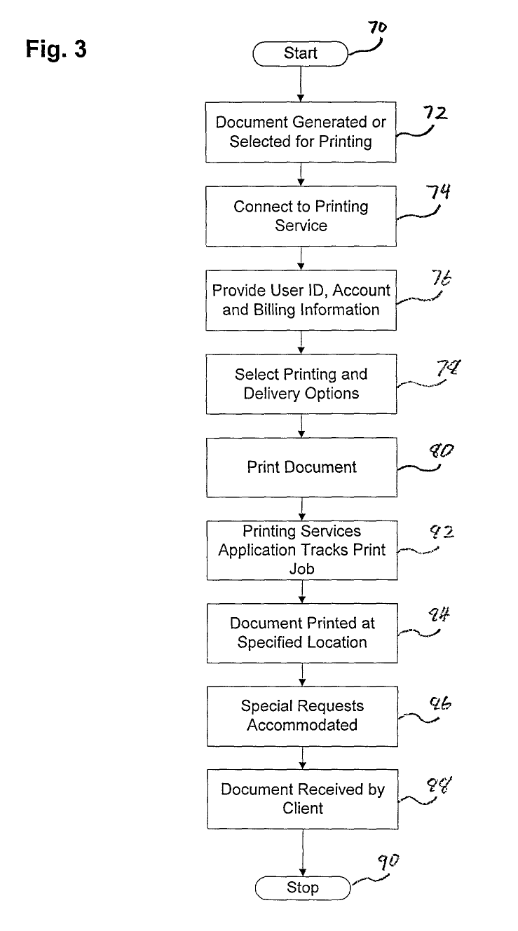

Now referring to FIG. 3, a method for providing aircraft computer printing services in accordance with the present invention starts in step 70. In step 72, an aircraft passenger 32, 34, 36 uses their computing device 38, 40, 42 to generate or select a document for printing. For example, the first passenger 32 may use the laptop computer 38 to create a word processing document. As a second example, second passenger 34 may use the PDA 40 to connect to the Internet through the communications link 12a connected to the local area network 30.

Once a document is created or selected in step 72, a connection is made to the printing services application, as indicated in step 74. In the first preferred embodiment, the connection to the printing services in step 74 involves connecting to the printing services application 22 resident in the ground based server 16, through the communications link 12a. In a second preferred embodiment, the connection to the printing service in step 74 involves connecting to the aircraft based server 44 and accessing the printing services application 22 resident in the aircraft based server 44.

Next, in step 76, a user identification (ID) and account information, including billing information such as a credit card number, is provided to the printing services application 22. The user identification and account information is used to track any print job initiated through the printing services application 22. Billing information is requested in order to charge the user for the services requested. In step 78, printing and delivery options are selected. This includes selecting the location for the printing of the document to take place. Through the printing services application 22, printing can be directed by the user to the on-board printer 48 or to a plurality of printers 18, 20 existing at remote locations, such as in an airport. After printing and delivery options are selected, the document is printed in step 80. This is done by printing in the usual manner for the application in use. The resulting print job is captured by the printing services application 22.

Next, in step 82, the printing services application 22 tracks the print job. This involves routing the print job to its destination where it is printed. For example, if the print job is routed to an airport, the printing services application 22 will monitor the print job to make sure that it is printed according to the selected specifications. The print services application will provide notification if the print job is not printed properly.

In step 84, a document is printed from the print job at the specified location. For example, the document is printed on-board the in-flight aircraft on the on-board printer 48. Alternatively, the document is printed on the first printer 18 or the second printer 20 at a remote location such as an airport. In step 86, special requests in the printing process are accommodated. For example, a special type or size of paper may be requested by the user for a given print job. Then, in step 88, the document is received by the client. This involves several options including picking up the document at the airport after the aircraft 10 has landed. It may also involve mailing the document, possibly via email, to the client's designated remote location pursuant to delivery options selected in step 78. The aircraft in-flight printing method ends at Step 90.

In summary, an aircraft passenger such as the first passenger 32 is able to connect their computing device to the wired network 46 on-board the aircraft and access a communications link 12a for connecting to a print services application 22 on a remote server 16. Advantageously, the first passenger 32 can select options for printing including the destination of the print job and pay for the printing services used. Thus, aircraft passengers can perform local (on the aircraft) or remote printing of documents without the necessity of bringing on-board a printer.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for enabling an aircraft passenger/crew member to print a document through an aircraft based network while travelling on the aircraft, comprising:
providing a computing device operated by the passenger/crew member;
connecting the computing device to the aircraft based network wherein the aircraft based network is connected to an aircraft based server comprising a print module for receiving a printing request from the computing device initiated by the aircraft passenger/crew member;
accessing the print module through the aircraft based network;
setting parameters in the print module for printing the document wherein the document is printed at a location designated by the passenger/crew member; and
printing the document according to the set parameters in the print module, wherein the print module routs the print request to the location designated by the passenger/crew member wherein the document is printed.

2. The method of claim 1 wherein the print module requests payment information from the passenger/crew member and transacts a charge for printing the document.

3. The method of claim 1 wherein the location designated by the passenger/crew member is selected from one of on-board the aircraft and at a ground based location.

4. The method of claim 1 wherein the computing device is selected from the group consisting of a laptop computer, a hand held computer, a telephone with an Internet connection capability.

5. The method of claim 1 wherein the aircraft based network comprises a local area network including a plurality of hard-wired connections available at a plurality of locations throughout the aircraft.

6. The method of claim 1 wherein the aircraft based network comprises a wireless local area network in communication with an interface card connected to the computing device.

7. A method for enabling passengers on an in-flight aircraft to print documents to a plurality of locations, comprising:
providing a computing device for initiating printing of a document;
using the computing device to initiate a print request for a user designated document;
connecting the computing device to a server disposed in the aircraft for receiving the document wherein the server is connected to a communications module in communication with a Receiver/Transmitter Subsystem for passing the print request from the aircraft to a ground based printing station; and
electronically transferring the document through the network to the ground based printing station wherein the document is printed.

8. A system for printing a document on an in-flight aircraft by an individual on the aircraft wherein the individual has a computing device connected to a network on-board the aircraft comprising:
an aircraft based network disposed in the aircraft for connecting to the individual's computing device;
an aircraft server connected to the aircraft based network wherein the aircraft server is operably associated with a satellite, wherein the aircraft server sends a signal to the satellite for relay of the signal to a ground based server connected to a ground based network;
a first print module operably associated with the aircraft server for accepting a request to print the document initiated by the individual wherein the aircraft server sends the request to the ground based server; and
a second print module operably associated with the ground based server for receiving the request to print from the first print module and directing the request to print to a printer wherein the document is printed.

9. A system for printing a document on an in-flight aircraft by a passenger on the aircraft wherein the passenger has a computing device connected to an aircraft based network, comprising:
an aircraft based network disposed in the aircraft for connecting to the passenger's computing device;
an aircraft server connected to the aircraft based network, wherein the aircraft server is operably associated with a satellite, and wherein the aircraft server sends a signal to the satellite for relay of the signal to a ground based server connected to a ground based network; and
a print module operably associated with the ground based server for receiving the request to print and directing the request to print to a printer wherein the document is printed.
